(19) United States
(12) Patent Application Publication
(10) Pub. No.: US 2025/0228253 A1
(43) Pub. Date: Jul. 17, 2025

(54) Method and Composition for Providing an Engineered Silica-Based Crystalline-Like Pathogen Barrier on Plants and Produce

(71) Applicant: Strategia Project Management, LLC, An Illinois Limited Liability Company, Oak Brook, IL (US)

(72) Inventor: Erwin Lo, Spring, TX (US)

(73) Assignee: Strategia Project Management, LLC, An Illinois Limited Liability Company, Oak Brook, IL (US)

(21) Appl. No.: 18/700,653

(22) PCT Filed: Oct. 11, 2022
(86) PCT No.: PCT/US2022/046306

§ 371 Date: Apr. 11, 2024

Related U.S. Application Data
(60) Provisional application No. 63/254,293, filed on Oct. 11, 2021.

(51) Int. Cl. A01N 65/22; A01N 25/02; A01P 3/00

(52) U.S. Cl. CPC A01N 65/22; A01N 25/02; A01P 3/00

(57) ABSTRACT

Inert silica dioxide solution that produces an antimicrobial effect by forming a crystalline-like barrier that remains on the treated surface and acts as a pesticide device that inhibits bacteria and viruses from attaching. When applied to a solid surface and allowed to dry, a 4-6 nm crystalline-like layer of SiO₂ bonds covalently to the base substrate. Direct binding occurs via the action of covalent bonding in which the silicon oxide layers with very high bond energy form surface and subsurface absorption layers followed by terminating desired bonding groups on out-most bonding surfaces and which can be polymerized into covalent bonds. These bonds are essentially permanent and can cover a large area as they disperse across the face of the targeted surface.

The protective SiO₂ crystalline-like layer has an increased resistance to moisture and the formed protective surface layer does not wash off once covalently bonded to a surface.

### CROSS-REFERENCE TO RELATED

The present application claims priority to and benefit from U.S. Provisional Patent Application No. 63/254,293, which was filed Oct. 11, 2021, the contents of which are hereby incorporated by reference in their entirety.

### TECHNICAL FIELD

The present disclosure generally relates to barrier coatings for surfaces, and in particular surface coatings for the avoidance of infection by fungi, mold, bacteria, viruses and the like on plants and produce.

### BACKGROUND OF THE INVENTION

Hemileia vastatrix is a multicellular basidiomycete fungus of the order Pucciniales that causes leaf rust, a disease affecting coffee plants, among others. Concerning rust infection, the coffee plant is an obligate host meaning that rust spores must come into physical contact with the plant in order to survive and cause infection. In this regard, rust is referred to as a parasitic fungus to the obligate coffee plant. There are thirty-two races of Hemileia vastatrix Roya that attack species of the genus Coffea, and especially plants of the Arabica species, but also others of the same genre.

As an obligate parasite, coffee leaf rust is transmitted when urediniospores (spores produced from the brown-red rust pustules) disperse from one part of the plant to another, or to a different plant. The spores are produced on the underside of the leaf from uredinia which make up part of the red/orange pustules on the undersides of the leaves. When the spores erupt from the pustules, they can be carried a few centimeters on air currents to the next leaf or hundreds of miles to plants distantly located. The spores can also travel short distances in rain-splash which is a common way for plant pathogens to travel from leaf to leaf of the same plant or tree.

When a spore contacts a leaf, it attaches to the surface of the leaf by way of spines on a rough side of the spore. To germinate, spores require the presence of liquid water on the leaf and a temperature between about 60° F. to about 80° F. Advantageously, the spores produce long tubes known as germ tubes that locate and latch onto the stomata of the leaves which are tiny openings in the leaf surface through which the plant breaths and releases water. The germ tubes include appressoria that are flattened fungal structures that produce tentacle-like hyphae that puncture into host tissue close to the stomata and ultimately into the host cells. The entire fungal infection process is completed in 24 to 48 hours and new urediniospores erupt from in the stomatal openings after 10 to 14 days. In this way, one rust lesion can produce 4 to 6 spore crops over a 3 to 5 month period and releasing as many as 300,000 to 400,000 spores into the environment to repeat the process.

All-in-all, the ideal conditions for the reproduction of rust spores is darkness, with a temperature of about 70° F. and low relative humidity. However, there must be water droplets on the leaf which are essential for spore germination. Regardless of whether the water droplets come from rain, dew, or irrigation, darkness provides the Roya its maximum capacity for germination. For these reasons, “hot-houses” where coffee plants are often grown, provide particularly favorable conditions for rust germination and infection.

### BRIEF DESCRIPTION OF THE DRAWINGS

FIG. 1 is a bar graph showing how the presently disclosed barrier essentially eradicates rust spores.

FIG. 2 illustrates the microSURE® engineered silica crystalline-like barrier layer showing the SiO2 structures that are formed after application of the microSURE® SiO2-containing solution to a surface.

FIG. 3 illustrates the “on contact” mechanical kill mechanism (characteristic) formed at the exposed surface of the microSURE® engineered silica crystalline-like barrier layer.

FIGS. 4-9 illustrate various treatment conditions and infection stages of a coffee plant including whether it is healthy or diseased and whether the illustrated plant is treated or untreated with microSURE® engineered silica crystalline-like barrier.

FIG. 10 is a three-dimensional graphic developed via an electron microscope at 100× magnification of a glass coverslip (slide) with no microSURE® SiO2-containing solution treatment applied.

FIG. 11, in its top portion, is a three-dimensional graphic developed via an electron microscope at 100× magnification of a glass coverslip with one treatment of colloidal silica dioxide coating (microSURE® engineered silica crystalline-like barrier) configured according to the present disclosure and applied to an edge of the coverslip; in the bottom portion of the figure, a line scan height analysis (essentially a cross-sectional view taken across the top illustration) is illustrated.

FIG. 12 is a three-dimensional graphic developed via an electron microscope of a glass coverslip with one treatment of colloidal silica dioxide coating (microSURE® engineered silica crystalline-like barrier) configured according to the present disclosure and applied to an edge of the coverslip and scratched with a utility knife.

FIG. 13 is a three-dimensional graphic developed via an electron microscope of a glass coverslip with one treatment of colloidal silica dioxide coating (microSURE® engineered silica crystalline-like barrier) configured according to the present disclosure and applied to an edge of the coverslip and scratched with a utility knife.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The presently disclosed technology for producing antimicrobial products was tested on coffee plants against fungal rust, specifically Hemileia vastatrix. It proved to have statistically significant efficacy against the fungus, as well as having a long-term residual antimicrobial effect. Additionally, tests on other types of plants including but not limited to strawberries, rice, marigolds, papaya, lime, grape, lettuces, green beans microgreens, heirloom tomatoes, and geranium plants. The present technology applies to any plant that could experience a fungal growth. As described herein, microSURE® refers to a solution of deionized water, silica (SiO₂), and rosemary oil. The ratio of deionized water to silica can be on the order of 30 to 1. The ratio of silica to rosemary oil can be on the order of 1 to 1. An example of an application is described herein below. The silica can be colloidal and amorphous. In at least one example, the silica can be diatomaceous earth. The diatomaceous earth can be a food grade variety, which allows the diatomaceous earth to be consumed without any negative effects on a human or other animal.

In an experiment, healthy garnica coffee plants were sampled in communities near the northeastern mountains of Teziutlán, Puebla, Mexico in order to determine and evaluate the transmission of rust fungus Hemileia vastatrix on coffee plants. The test was carried out at 1680 meters above sea level in the town of San Juan Acateno in Teziutlán. Healthy plants without rust infection that were treated with the presently disclosed microSURE® SiO₂-containing solution that was subsequently permitted to dry and form the protective SiO₂ crystalline-like layer. The experiment also included the treatment of rust infected plants with the microSURE® SiO₂-containing solution. While the rust abatement was most visible on the coffee plant leaves, it should be appreciated that the protective product was also applied to other parts of the plants including stems, flowers, and fruit.

Subsequently, the plants were monitored daily for a period of twelve days under conditions that would foster the development of the rust fungus to sporulation and the spread of spores. It was observed that unprotected plants had severe plant fungus infection (rust), but the plants protected with the microSURE® SiO₂-containing solution had essentially no spread of rust (Hemileia vastatrix).

The main objective of the microSURE® barrier-forming composition is to protect the plant crop by its formation of the nanometric protective layer on the plants' surfaces that deter the development of fungi, molds, viruses, and bacteria. In the currently disclosed experiment/study, focus is on the established nanometric protective layer's ability to control rust fungus (Hemileia vastatrix) on coffee plants. In the study, healthy plants treated with microSURE® SiO₂-containing solution did not develop rust infection. However, similar healthy plants that went untreated in the same space did develop rust fungus. Surprisingly though, the progression of rust infection on infected plants ceased upon treatment with the microSURE® SiO₂-containing solution, and future infection was avoided by the formation of the protective SiO₂ crystalline-like layer. Not surprising, untreated, infected plants succumbed to rust infection.

In this reported field experiment that was conducted over the course of 15 days, none of the plants on which the microSURE® engineered silica crystalline-like barrier was established showed symptoms of infection despite rust exposure in high-humidity, high-temperature greenhouses and on which water droplets were present. The plants were inspected three times daily for rust infection symptoms, but none developed.

The microSURE® SiO₂-containing composition comprises a solution of inert silica dioxide (SiO₂) formed from colloidal silica dioxide dissolved into a stable, aqueous solution using deionized water. This solution is initially created as an ultra-concentrate, which has tremendous versatility, as it is easily diluted into various ready-to-use formulations. The base concentrate can also be diluted and formulated as a pesticide and fungicide for use on plants.

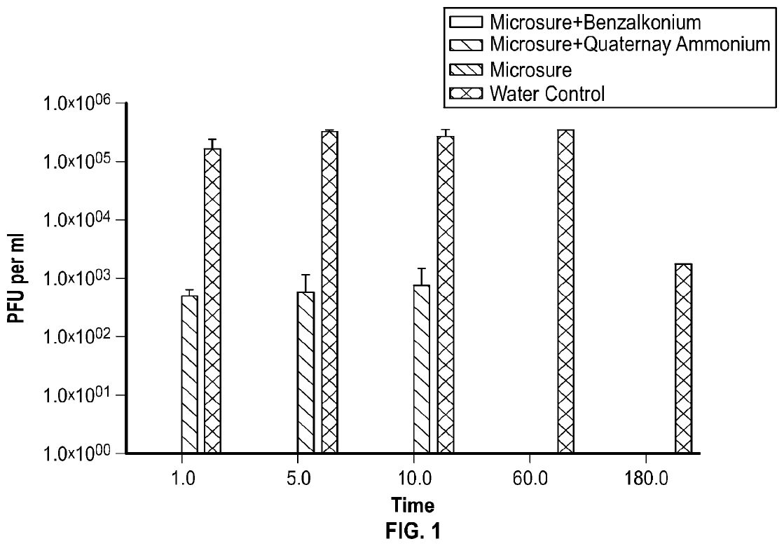

FIG. 1 is a bar graph showing how the presently disclosed microSURE® SiO2-containing solution that dries into the described microSURE® engineered silica barrier essentially eradicates rust spores in about 60 minutes (left-hand bar of each pair) after wet-application compared to the water-control (right-hand bar of each pair) that has essentially no effect on the rust spores in the first 60 minutes after wet-application. FIG. 1 also signifies the capability of the microSURE® SiO2-containing solution, when mixed with either (i) benzalkonium chloride or (2) quaternary ammonium and wet-applied to a surface, to essentially eradicate targeted live pathogens on contact. This capability is demonstrated by the absence of corresponding bars on the graph for either of the top-two formulations referenced in the legend in the upper right corner of FIG. 1. Therefore, the microSURE® engineered silica barrier functions significantly without the need for additional chemicals that have been traditionally used in combination or separate from silica barriers in the past. This is a surprising result.

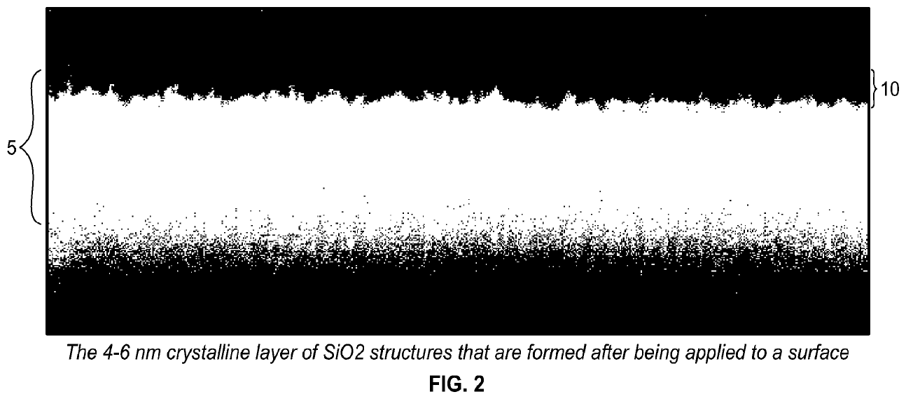

FIG. 2 illustrates the microSURE® engineered silica crystalline-like barrier layer 5 showing the SiO₂ structures 10 that are formed after application of the microSURE® SiO2-containing solution to a surface. The structures 10 resemble ‘spikes’ that form. The illustrated barrier formed on plants is substantially the same regardless of the type of plant. All exhibit the spikes 10 that are illustrated. Additionally, small dots are shown throughout the barrier and these depict the way the silica interacts with itself to form the spikes 10.

The silica dioxide solution, while an inert component of the described compositions, contributes an antimicrobial effect to the end products by forming a crystalline-like barrier that remains on the treated surface and acts as a pesticide device that inhibits bacteria and viruses from attaching. When applied and allowed to dry, a 4-6 nm crystalline-like layer of SiO₂ bonds covalently (permanently) to the base substrate (surface being treated). The crystalline-like structures making up the “new” surface cannot be seen with the naked eye, but the new surface can be observed using a high-powered electronic microscope, as provided in FIG. 2. Beneficially, the established protective layer does not alter the appearance of the receiving surface and is essentially invisible.

This direct binding occurs via the action of covalent bonding. Experimentation has shown that covalent bonding of silicon oxide layers with very high bond energy can be realized by forming surface and subsurface absorption layers followed by terminating desired bonding groups on out-most bonding surfaces and which can be polymerized into covalent bonds. This process results in a by-product that can be easily absorbed by and dispersed by the absorption of a variety of surfaces. The experiment also demonstrated the strength of the covalent bonds that are formed once the colloidal silica dioxide reaches and attaches to various surfaces. These bonds are essentially permanent and can cover a large area as they disperse across the face of the targeted surface. The experiment also revealed that the use of silica dioxide as described herein in the formation of the protective SiO₂ crystalline-like layer has an increased resistance to moisture and the formed protective surface layer does not wash off once covalently bonded to a surface.

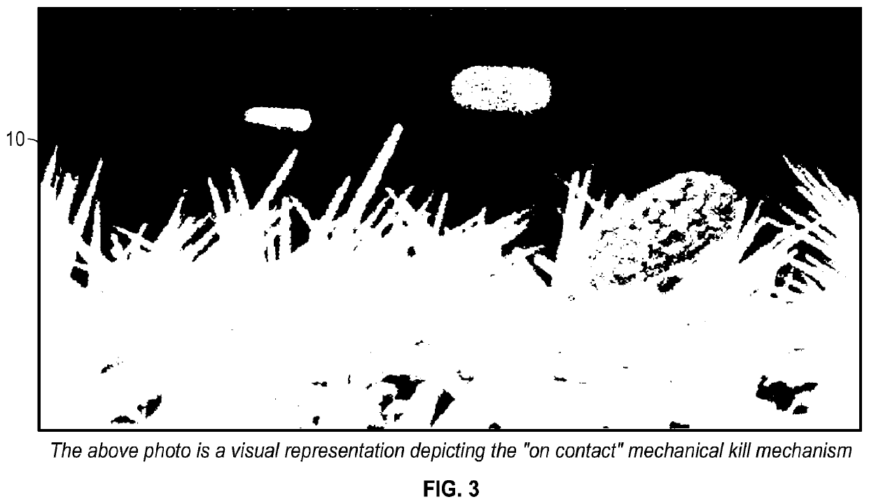

FIG. 3 illustrates the “on contact” mechanical kill mechanism (characteristic) formed at the exposed surface of the microSURE® engineered silica crystalline-like barrier layer. Once the silica dioxide solution is applied to a surface, the crystalline-like structures that make up the resulting “modified” surface contain microscopic spikes that physically work to penetrate the outer membranes and protein coats of microorganisms that come into contact with the surface, rendering them dead in the case of bacteria and fungi and inactive in the case of viruses. The combination of nano-silica and water-mist lead to a greater shear bond strength when applied to a surface, thereby supporting the finding that the covalent bond formed between the silica technology and the surface can adhere for extended durations based on the established properties. The resulting silica dioxide barrier can remain on the surface for an extended period, offering protection until it is abraded or soiled over. As a result, the protective barrier is effective both at the time of application and well after.

The antimicrobial surface protectant has proven to be effective against many destructive microorganisms. It effectively kills, controls, and aids in the future prevention of infection by bacteria, fungi and other harmful organisms/pathogens.

The results of the described experimentation demonstrate that the microSURE® engineered silica crystalline-like barrier surface protectant prevented colonization and growth of infectious microorganisms at both 30 minutes (showing that the solution begins to take effect immediately) and 24 hours (showing the solution offers continued protection). In contrast, samples treated with the non-microSURE® disinfectant showed growth of infectious colonies at both time periods. The results demonstrated that the anti-microbial treatment created a surface modification that caused cell membrane disruption and death to various bacteria upon contact to the cell membrane.

The nanotechnology characteristics associated with the disclosed silica dioxide solution enables attachment to surfaces via covalent bonds, thereby creating a physical pesticide device in the form of a barrier layer that lasts on treated surfaces for an extended period of time. Moreover, as described above, several experiments conducted on so-formed surface layer coatings demonstrated continued antimicrobial effect after 24 hours. The mechanical kill mechanism established by the silica dioxide crystalline-like matrix lasts for as long as the mechanical agent remains on the surface. As a result, the protective barrier is effective shortly after application of the solution, and well after. The described compositions contain a silica dioxide component that, once applied, forms microcrystalline structures that form a covalent bond with the targeted surface. This mechanical barrier protects the surface from adherence of harmful microbes, as the crystalline-like structures contain microscopic spikes that penetrate the outer membranes of the microbes, rendering them unable to attach to the surface. Generally, this barrier remains on the treated surface until abraded away.

In these regards, there is a need for non-irritating, antimicrobial (efficacious against bacteria and viruses) substances that have residual effectiveness against harmful pathogens for relatively long periods of time. Currently, the majority of antimicrobial or biocidal agents are only effective while they are wet and traditionally have necessarily contained harsh, irritating and potentially harmful chemicals as their active ingredient(s). Therefore, products that do not require such harmful chemicals for effective pathogen control, over long periods of time, provide great user benefits.

This technology establishes an elemental colloidal silica dioxide coating that provides a barrier against pathogenic microbes. While the use of silica in combination with certain metals such as silver, copper and gold has been previously described as having certain antimicrobial effects, the present technology of an engineered nanomolecular colloidal silica that itself has antimicrobial effect and potentiates the effect of other active antimicrobial ingredient(s) when included in minimal amounts.

As disclosed above, the engineered crystalline-like structures created in accordance with the presently disclosed technology are visually apparent under high powered electron microscopy after the silica dioxide-containing solution is applied on a surface and dries forming the barrier coating on the now-treated surface. Uniquely, the formed barrier coating has proven to be an effective antimicrobial barrier solely with inert ingredients. Moreover, the established barrier has been shown to meet a baseline of log 3 viricidal reduction within two hours. When applied to essentially any solid surface and allowed to dry, a 4-6 nm crystalline-like layer of silica dioxide bonds covalently (permanently) to the substrate. The crystalline-like structures making up the “new” surface cannot be seen with a naked eye but can be observed via a high-powered electronic microscope. Once silica dioxide is applied to a surface, the crystalline-like structures that make up the resulting “modified” surface contain microscopic spikes that physically work to penetrate the outer membranes and protein coats of microorganisms that come into contact with the surface, rendering them dead in the case of bacteria and fungi or inactive in the case of viruses.

It is known that chemical kill mechanisms are only short-term effective. The short-term limitation stems from the inactivation of the chemical kill once the chemical agent has dried, which may be mere seconds after application. In some settings, immediate pathogen eradication, without residual effect is sufficient, and even desired. There are many settings in which residual pathogen neutralization is desired, and it is in these instances that the current technology shines. In accordance with the present disclosure, a mechanical kill function is established by way of the silica dioxide matrix that lasts for as long as the mechanical agent remains on the surface. As a result, the product is effective shortly after application and well after.

As addressed above, the presently disclosed composition embodies a silica dioxide matrix that, once applied, forms microcrystalline structures that form a covalent bond with the targeted surface. This mechanical barrier protects the surface from adherence of harmful microbes by way of the crystalline-like structures' inclusion of the microscopic spikes that penetrate the outer membranes of the microbes, rendering them unable to attach to the surface. This barrier can remain on the surface for an extended period.

The nanotechnology associated with the presently disclosed silica dioxide solution is able to attach to surfaces via covalent bonds, thereby creating a physical “pesticide device” barrier that lasts on surfaces for an extended period of time. Moreover, the barrier has been shown to exist after 24 hours and as long as 21 days. In some instances, where there is already existing infection, the application can be structured in application such as on day 1, day 3, and day 7. In other examples, the last day of the first week for application can either be day 5 or day 6 instead of day 7. Furthermore, the reapplication after day 7 can ben done either day 14, day 21, or day 28.

Additionally, the presently claimed solution also includes rosemary oil. In at least one example, the rosemary oil can be an organic rosemary oil. In at least one example, the rosemary oil acts to immediately treat the fungus that is present on the plant. In doing so, the protective coating formed by the microSure product allows for enhanced staying power as the fungus will not break through the protective layer from by the microSure product. The solution as presented herein provides for a surprising benefit as the expected properties were only considered for surfaces that were hard and non-porous as compared to plants. Additionally, the surface after being treated by microSure exhibits properties that provide for an effective filter of the natural light to result in uptake of light by the plant that is more favorable than even natural light. This was a surprising result. Furthermore, the ability of the barrier to remain in place beyond a week was surprising given the solution. Typical retreatment was not required until after twelve days. In at least one instance, the protection can be up to twenty-one days, such that protection lasts a predetermined time that is between seven and twenty-one days.

In at least one example, the silica can be in the form of diatomaceous earth. In at least one example, the diatomaceous earth can be a food grade diatomaceous earth. The food grade diatomaceous earth is safe for consumption by humans and other animals. Thus, the solution as described herein is safe for consumption by humans and animals. In at least one example, the solution can include less than 1% of isopropyl alcohol. The amount of isopropyl alcohol can be in the range between 0.01% and 1%. In another example, the range can be between 0.01% and 0.05% isopropyl alcohol. The isopropyl alcohol allows for the solution to have a lower surface tension thereby increasing coverage area as well as being able to spread easily over the plant once applied. Additionally, sodium bicarbonate can be included in the solution. The amount of sodium bicarbonate in solution can be between 0.01% and 1%. In another example, the range for the sodium bicarbonate in solution can be between 0.01% and 0.05%. These small amounts of other ingredients allow for the primary component of silica in solution to form a protective coating that is antimicrobial, antifungal, anti-spore forming and/or anti-biofilm forming. The ability to create a single solution that is effective against virus, fungus, spores and biofilms was surprising as previous attempts used a variety of different chemicals. The present solution utilizes silica that has a particle size on the order of 4-6 nanometers. In at least one example, the present solution utilizes silica with a particle size less than 4 nanometers. In yet another example, the silica particle size can be four nanometers or less. The particle size allows for the coating to remain in place even during abrasion and spraying with water. This is important in the application to crops that experience rain and contact with insect feet among other abrasive conditions. The present solution allows for a unique bond shape and size. The solution allows for a covalent bond with the plants thereby preventing the surface from being removed by wide array of environmental factors including extreme temperature and environmental factors. The present solution when dried can resist temperatures. Some examples are provided herein that illustrate the ability to resist fungus, virus, spores, and biofilms. Additionally, the presently disclosed solution can have a shelf life longer than 5 years. In at least one example, the shelf life can be greater than 7 years. The solution is unique in that the silica stays in suspension beyond the shelf life of many products that only provide for a shelf life of 1 or 2 years. This is aided by the solution of silica in which silica is less than 10% by volume of the solution. In at least one example, the amount of silica can be between 1% to 10% by volume of the solution. In another example, the amount of silica can be on the order of 1% to 5% by volume of the solution. In yet another example, the silica is less than 5% of the solution. In at least one example, the amount of silica can be on the order of about 5% by volume of the solution. The solution is applied to plants by spraying the plants and letting the solution dry. The solution only needs about 2 hours or less to dry. This is a very fast drying time. It allows for the solution to be used in very wet climates that experience daily rainfall. This is a surprising result as other anti-fungal solutions need typically 8 or more hours prior to rainfall to achieve protection and only provide protection for 1 to 2 days. The bulk of the solution is deionized water. This allows for the solution to be applied to plants with a sprayer.

In at least one example, the present solution can consist of deionized water, silica, rosemary oil, isopropyl alcohol, and sodium bicarbonate. As described above, the silica is less than 10% of the solution, the rosemary oil is less than 1% of the solution, the isopropyl alcohol is less than 1% of the solution, and the sodium bicarbonate is less than 1% of the solution. In yet another example, the silica is less than 5% of the solution, the rosemary oil is less than 0.5% of the solution, the isopropyl alcohol is less than 0.5% of the solution, and the sodium bicarbonate is less than 0.5% of the solution. In still another example, the silica is less than 5% of the solution, the rosemary oil is 0.01% of the solution, the isopropyl alcohol is less than 0.5% of the solution, and the sodium bicarbonate is less than 0.5% of the solution.

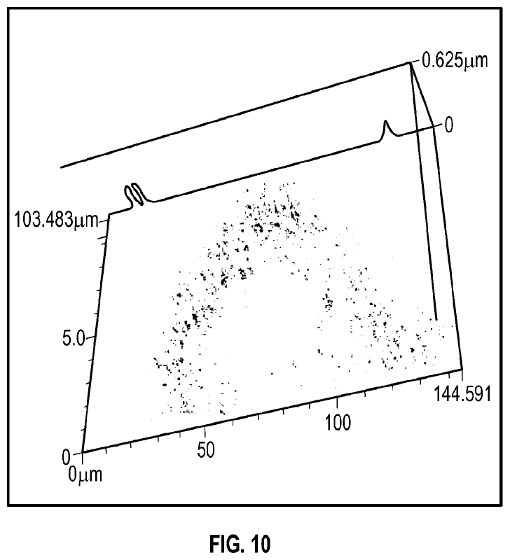

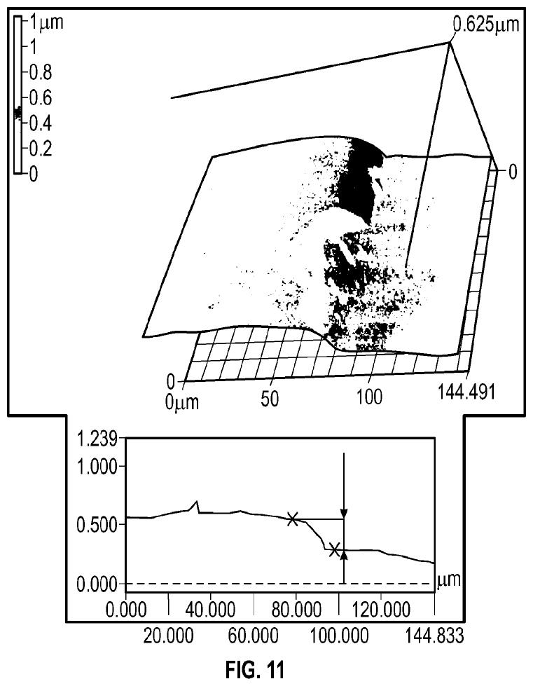

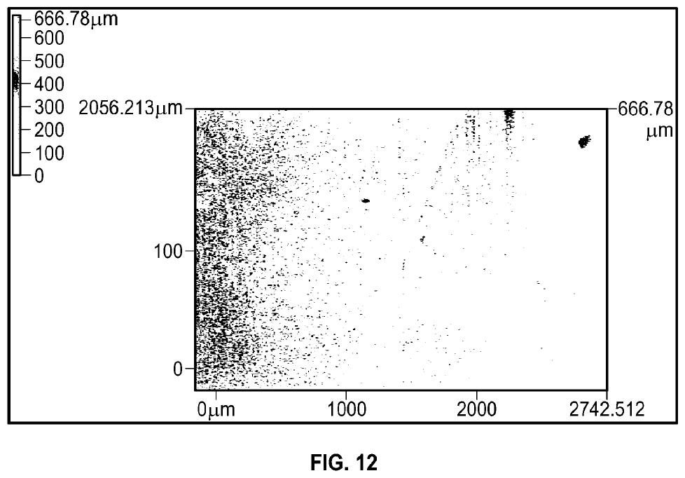

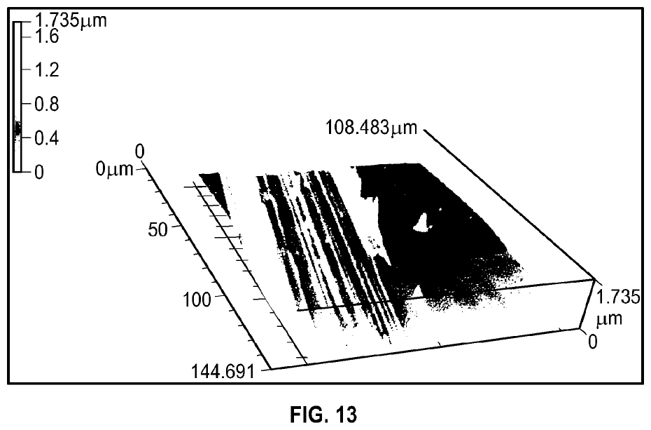

FIG. 10 and FIG. 11 depict a glass slide before and after application of a nanomolecular colloidal silica dioxide coating containing silica dioxide. These images clearly depict the physical, three-dimensional coating created following application of the silica dioxide solution. In addition, laboratory testing has demonstrated that use of a razor, applied with force, is required to remove (abrade) the crystalline-like barrier from a treated surface. The images of FIG. 12 and FIG. 13 depict a slide treated with a silica dioxide solution according to the disclosed technology and subsequently scratched with a utility knife which shows that even when abraded-away with robust force using a blade, there is still residual silica present forming a pathogen barrier.

The demonstrated ability of silica dioxide to form a covalent bond with surfaces has multiple demonstrated and potential benefits. It has been shown that the use of silica dioxide in accordance with this disclosure can have positive effects related to cellular function and therefore skin-related function, provides benefits in bone tissue engineering and can increase resistance to moisture and corrosion on surfaces. These studies also supports the silica dioxide's ability to act mechanically as a pesticide device that physically prevents further entry of unwanted microbes. This makes the solution effective as a surface protectant (internal and external) over an extended period.

The presently describe solution is considered within use for organic use and production. The application can be through an electrostatic sprayer and set to a very fine mist setting and perhaps the finest mist setting for the sprayer. The finer the mist the greater adhesion and coverage. Application is done such that mist covers all areas of the plant surfaces. The application is done on a 5-7 day basis until flowering occurs.

The present disclosure also contemplates a method of protecting plants against fungus, microorganisms, spores, and/or biofilms. The method can include diluting a concentrated solution according to the present disclosure. The method can also include spraying the diluted solution on one or more plants. The method further includes allowing the diluted solution to dry on the plant.

Still further, the method can include applying another spray containing a solution of deionized water, silicia, and rosemary oil after a predetermined time has elapsed. The predetermined time is based upon the amount of exposed area not covered by the spray. The predetermined time can be between 5 and 21 days. In another example, the predetermined time can be between 7 and 21 days. In yet another example, the predetermined time can be between 5 and 14 days. In yet another example, the method can further include spraying the solution on one or more plant surfaces having Hemileia vastatrix.

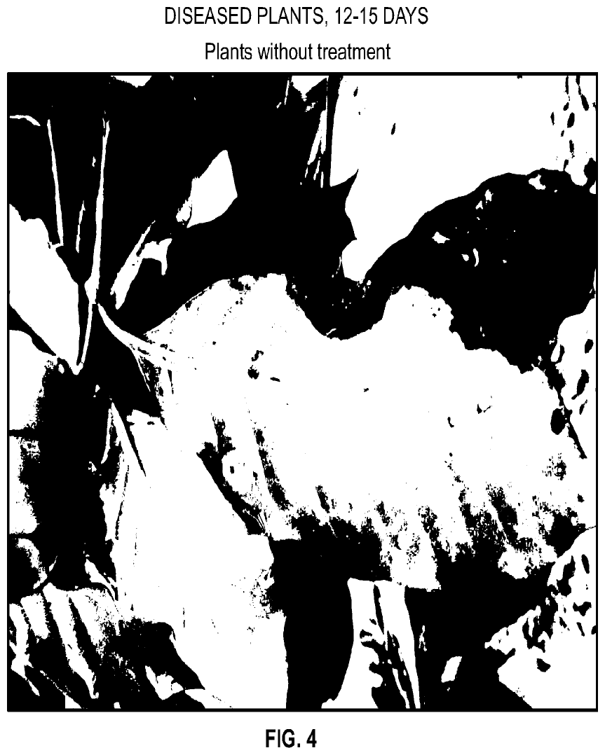

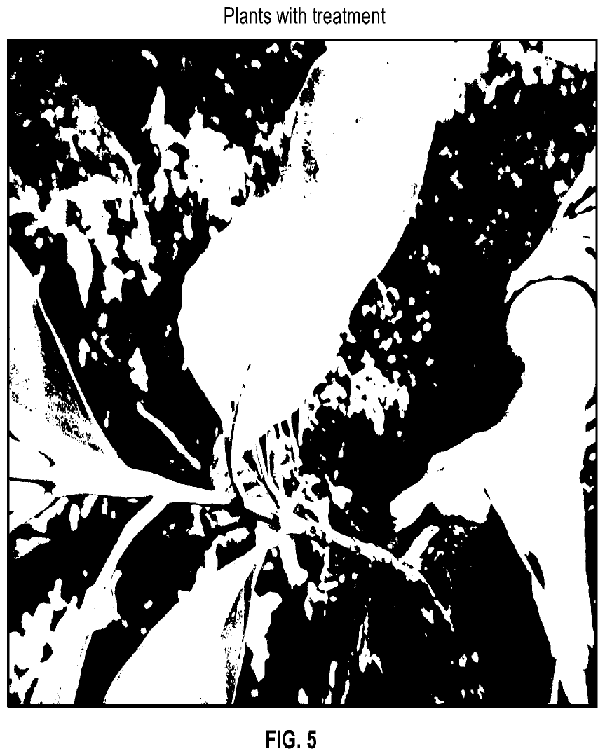

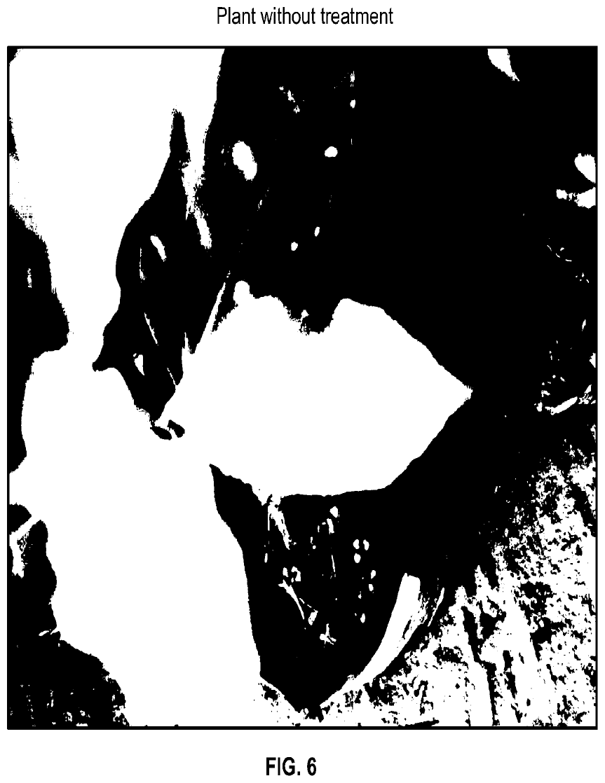

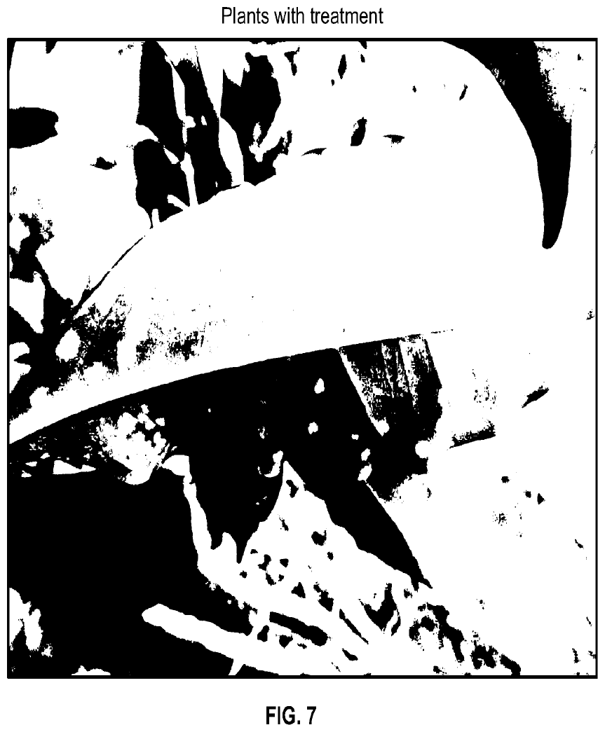

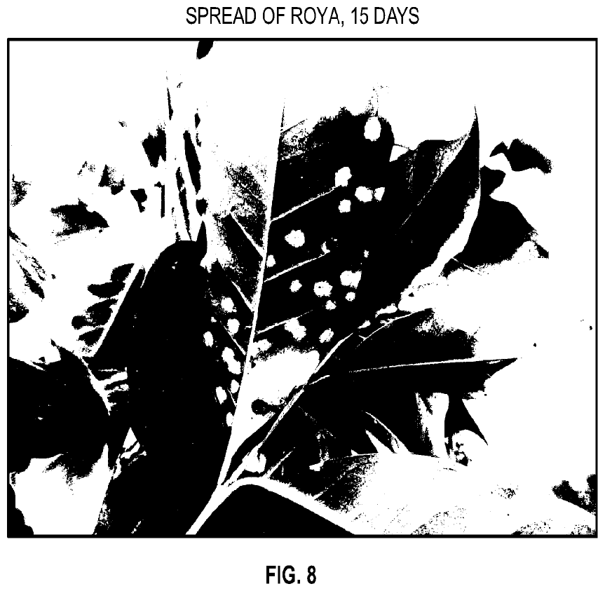

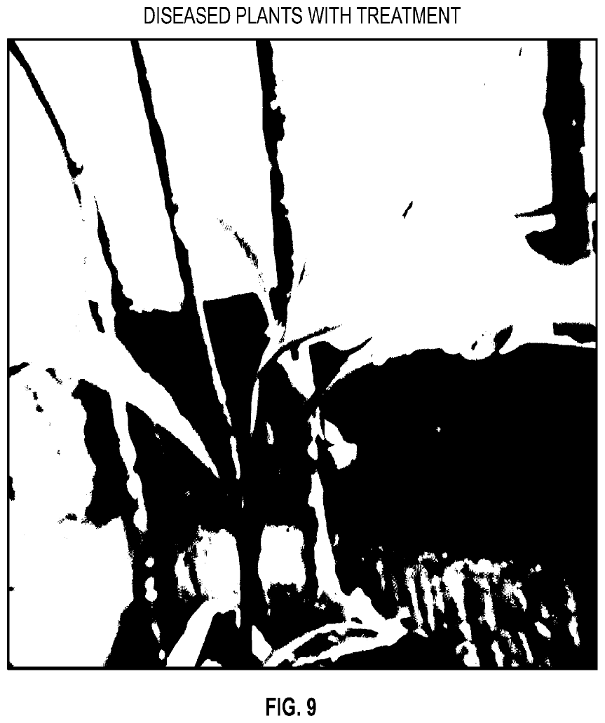

FIGS. 4-9 illustrate various treatment conditions and infection stages of a coffee plant including whether it is healthy or diseased and whether the illustrated plant is treated or untreated with microSURE® engineered silica crystalline-like barrier.

The present solution was tested against Hemileia vastatrix and in comparison to timsen on coffee plants. The results where equal or better than timsen and that there was zero phytotoxicity for the present solution. Furthermore, there was no damage to the beneficial fauna in the trial zone. In a second test, 40 healthy plants were selected and divided into two groups. The first group received the solution as presented herein and the other was left untreated. All of the plants were then sprayed with Hemileia vastatrix solution. The test showed that 45% of the untreated plants contracted the disease and those that received the presently described solution has 100% health and remained unaffected.

Another test was done on Marigold plants. The results where those that were treated with the present solution demonstrated a 133% increase in average size and a 368% increase in bloom count. Yet another test was done with rice in which the present solution application was compared with traditional fungicide products with the result being that an increase in production was experienced for those crops that received the present solution. Still another test was done with papaya that resulted in larger fruits compared with the traditional fungicide. Yet another test was done with limes resulting in no unhealthy limes found for those with solution applied. Still another test was done for strawberries in which the total weight was greater than untreated and the test was considered to be the same. Still another test was done with grapes in which the product was 100% successful in preventing growth of powdery mildew. Still another test was done on geranium and vinca vines that resulted in a 30-40% increase in fullness compared to untreated vines. Yet other tests were done on microgreens, lettuces, green beans, and heirloom tomatoes. The ladybugs that normally eat aphids were not noticed on the plants that were treated and no aphids were found as well. The plants had a 10% increase in growth compared to the untreated plants that relied on the ladybugs.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

While the disclosure has been particularly shown and described with reference to specific embodiments thereof, it will be understood by those skilled in the art that the foregoing and other changes in form and details may be made therein without departing from the spirit and scope of the invention.

While examples of the present disclosure have been shown and described herein, it will be obvious to those skilled in the art that such examples are provided by way of example only. Numerous variations, changes, and substitutions will now occur to those skilled in the art without departing from the disclosure. It should be understood that various alternatives to the examples of the disclosure described herein can be employed in practicing the disclosure. It is intended that the following claims define the scope of the disclosure and that methods and structures within the scope of these claims and their equivalents be covered thereby.

Illustrative examples of the disclosure include:

Aspect 1: A nanometric protective solution for application to plants comprising: deionized water; silica; rosemary oil.

Aspect 2: The nanometric protective solution of Aspect 1, wherein the silica is less than 10% of the solution.

Aspect 3: The nanometric protective solution of any one of Aspects 1 to 2, wherein the silica is between 1% and 10% of the solution.

Aspect 4: The nanometric protective solution of any one of Aspects 1 to 3, wherein the silica is less than 5% of the solution.

Aspect 5: The nanometric protective solution of any one of Aspects 1 to 4, wherein the silica is a food grade diatomaceous earth.

Aspect 6: The nanometric protective solution of any one of Aspects 1 to 5, wherein the silica has a particle size of six nanometers or less.

Aspect 7: The nanometric protective solution of any one of Aspects 1 to 6, wherein the silica has a particle size of four nanometers or less.

Aspect 8: The nanometric protective solution of any one of Aspects 1 to 7, further comprising isopropyl alcohol and sodium bicarbonate.

Aspect 9: The nanometric protective solution of any one of Aspects 1 to 8, wherein the isopropyl alcohol and sodium bicarbonate each are less than 1% of the solution.

Aspect 10: The nanometric protective solution of any one of Aspects 1 to 9, wherein the rosemary oil is less than 1% of the solution.

Aspect 11: The nanometric protective solution of any one of Aspects 1 to 10, wherein the solution consists of deionized water, silica, rosemary oil, isopropyl alcohol, and sodium bicarbonate.

Aspect 12: The nanometric protective solution of Aspect 11, wherein the silica is less than 10% of the solution, the rosemary oil is less than 1% of the solution, the isopropyl alcohol is less than 1% of the solution, and the sodium bicarbonate is less than 1% of the solution.

Aspect 13: The nanometric protective solution of Aspect 12, wherein the silica is less than 5% of the solution, the rosemary oil is less than 0.5% of the solution, the isopropyl alcohol is less than 0.5% of the solution, and the sodium bicarbonate is less than 0.5% of the solution.

Aspect 14: The nanometric protective solution of Aspect 12, wherein the silica is less than 5% of the solution, the rosemary oil is 0.01% of the solution, the isopropyl alcohol is less than 0.5% of the solution, and the sodium bicarbonate is less than 0.5% of the solution.

Aspect 15: A method of protecting plants against fungus comprising: diluting a concentrated solution according to any one of Aspects 1 to 12; spraying the diluted solution on one or more plants; allowing the diluted solution to dry on the plant.

Aspect 16: The method of protecting plants against fungus of Aspect 15, further comprising: applying another spray containing a solution of deionized water, silicia, and rosemary oil after a predetermined time has elapsed, wherein the predetermined time is based upon the amount of exposed area not covered by the spray.

Aspect 17: The method of protecting plants against fungus of Aspect 16, wherein the predetermined time is between seven and twenty one days.

Aspect 18: The method of protecting plants against fungus of Aspect 16, further comprising: spraying the solution on one or more plant surfaces having Hemileia vastatrix.

What is claimed is:

1. A nanometric protective solution for application to plants comprising:
deionized water;
silica;
rosemary oil.

2. The nanometric protective solution of claim 1, wherein the silica is less than 10% of the solution.

3. The nanometric protective solution of any one of claims 1 to 2, wherein the silica is between 1% and 10% of the solution.

4. The nanometric protective solution of any one of claims 1 to 3, wherein the silica is less than 5% of the solution.

5. The nanometric protective solution of any one of claims 1 to 4, wherein the silica is a food grade diatomaceous earth.

6. The nanometric protective solution of any one of claims 1 to 5, wherein the silica has a particle size of six nanometers or less.

7. The nanometric protective solution of any one of claims 1 to 6, wherein the silica has a particle size of four nanometers or less.

8. The nanometric protective solution of any one of claims 1 to 7, further comprising isopropyl alcohol and sodium bicarbonate.

9. The nanometric protective solution of any one of claims 1 to 8, wherein the isopropyl alcohol and sodium bicarbonate each are less than 1% of the solution.

10. The nanometric protective solution of any one of claims 1 to 9, wherein the rosemary oil is less than 1% of the solution.

11. The nanometric protective solution of any one of claims 1 to 10, wherein the solution consists of deionized water, silica, rosemary oil, isopropyl alcohol, and sodium bicarbonate.

12. The nanometric protective solution of claim 11, wherein the silica is less than 10% of the solution, the rosemary oil is less than 1% of the solution, the isopropyl alcohol is less than 1% of the solution, and the sodium bicarbonate is less than 1% of the solution.

13. The nanometric protective solution of claim 12, wherein the silica is less than 5% of the solution, the rosemary oil is less than 0.5% of the solution, the isopropyl alcohol is less than 0.5% of the solution, and the sodium bicarbonate is less than 0.5% of the solution.

14. The nanometric protective solution of claim 12, wherein the silica is less than 5% of the solution, the rosemary oil is 0.01% of the solution, the isopropyl alcohol is less than 0.5% of the solution, and the sodium bicarbonate is less than 0.5% of the solution.

15. A method of protecting plants against fungus comprising:
diluting a concentrated solution according to any one of claims 1 to 14;
spraying the diluted solution on one or more plants;
allowing the diluted solution to dry on the plant.

16. The method of protecting plants against fungus of claim 15, further comprising:
applying another spray containing a solution of deionized water, silicia, and rosemary oil after a predetermined time has elapsed, wherein the predetermined time is based upon an amount of exposed area not covered by the spray.

17. The method of protecting plants against fungus of claim 16, wherein the predetermined time is between seven and twenty one days.

18. The method of protecting plants against fungus of claim 16, further comprising:
spraying the solution on one or more plant surfaces having Hemileia vastatrix.
